(19) United States
(12) Patent Application Publication
(10) Pub. No.: US 2016/0034686 A1
(43) Pub. Date: Feb. 4, 2016

(54) PASSWORD CONFIGURATION AND LOGIN

(71) Applicant: Alibaba Group Holding Limited, Grand Cayman (KY)

(72) Inventor: Guanghui Yin, Hangzhou (CN)

(21) Appl. No.: 14/808,317

(22) Filed: Jul. 24, 2015

(30) Foreign Application Priority Data
Jul. 30, 2014 (CN) 201410369347.3

(51) Int. Cl. G06F 21/46; G06F 21/31

(52) U.S. Cl. CPC G06F 21/46; G06F 21/31

(57) ABSTRACT

Password characters input by a user as an account password are obtained. A password table including the password characters and a preset number of supplemental characters is randomly generated. An indication table indicating the password characters as the account password in the password table is generated. The password table and the indication table are stored. The techniques of the present disclosure improve password security.

### CROSS-REFERENCE TO RELATED PATENT APPLICATION

This application claims foreign priority to Chinese Patent Application No. 201410369347.3 filed on 30 Jul. 2014, entitled “Method and Device for Password Configuration and Login,” which is hereby incorporated by reference in its entirety.

### TECHNICAL FIELD

The present disclosure relates to the technical field of computer technology, and, more particularly, to a method and apparatus for password configuration and login.

### BACKGROUND

In conventional techniques, an account password configured by a user is usually composed of numbers, capitalized or non-capitalized letters, and some special symbols. These characters that are used for an account password are saved at a terminal device so that, when the user logs in, the terminal device compares the characters input by the user for logging in with characters stored at the device. If the two are the same, the user is allowed to log in.

If a hacker uses software, such as Trojan, to hack into the device, the hacker can easily obtain some key information from the device, such as the characters used as the password, and thus the hacker can log in as the user and conduct many illegal operations, thereby causing many troubles and losses to the user. Thus, password security in a conventional password configuration is weak.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

The present disclosure provides a method and device for password configuration and login to provide a new password configuration and improve password security.

The present disclosure provides a password configuration method. Password characters input by a user as an account password are obtained. A password table including the password characters and a preset number of supplemental characters is randomly generated. An indication table indicating the password characters as the account password in the password table is generated. The password table and the indication table are stored.

The present disclosure also provides a login method. A login password input by a user is obtained. Password characters used as an account password are determined from a password table according to an indication table. The password table includes the password characters as the account password and a preset number of supplemental characters. The indication table indicates the password characters as the account password in the password table. The login password is compared with the account password. If a comparing result is that the login password is the same as the account password, the user is allowed to login.

The present disclosure also provides a password configuration device, which may include the following modules: an obtaining module that obtains password characters input by a user as an account password; a first generating module that randomly generates a password table including the password characters and a preset number of supplemental characters; a second generating module that generates an indication table indicating the password characters as the account password in the password table; and a storing module that stores the password table and the indication table.

The present disclosure also provides a password login device, which may include the following modules: an obtaining module that obtains a login password input by a user; a determining module that determines password characters used as an account password from a password table according to an indication table, the password table including the password characters as the account password and a preset number of supplemental characters, the indication table indicating the password characters as the account password in the password table; a comparing module that compares the login password with the account password; and a logging-in module allows the user to log in if a comparing result is that the login password is the same as the account password.

The techniques of the present disclosure, after the user inputs the password characters used as the account password, randomly generate the password table including the password characters and supplemental characters and mix the password characters and the supplemental characters. Even if the password table is hacked, it is difficult for the hacker to determine the password characters as the account password, which improves password security. In addition, the techniques of the present disclosure use the indication table to indicate the password characters as the account password in the password table, thereby solving the problem of determining password when the user logs in. Although such two tables may be used to determine the password characters as the account password, a possibility that both of the two tables are hacked is low. Even if both of the two tables are hacked, it is difficult for the hacker to analyze a relationship between the two tables. Therefore, the techniques of the present disclosure improve password security.

### BRIEF DESCRIPTION OF THE DRAWINGS

To illustrate the technical solutions of the example embodiments of the present disclosure, the accompanying drawings are briefly described below. It is apparent that the FIGs are only part of the embodiments of the present disclosure. One of ordinary skill in the art may obtain other drawings based on the FIGs without using creative efforts.

FIG. 1 is a flow chart of an example password configuration method according to an example embodiment of the present disclosure.

FIG. 2 is a diagram of an example display of prompt message for password configuration according to an example embodiment of the present disclosure.

FIG. 3 is a diagram of another example display of prompt message for password configuration according to an example embodiment of the present disclosure.

FIG. 4 is a diagram of an example password table according to an example embodiment of the present disclosure.

FIG. 5 is a flow chart of an example login method according to an example embodiment of the present disclosure.

FIG. 6 is a diagram of an example display of prompt message for login according to an example embodiment of the present disclosure.

FIG. 7 is a diagram of another example display of prompt message for login according to an example embodiment of the present disclosure.

FIG. 8 is a structural diagram of an example password configuration device according to an example embodiment of the present disclosure.

FIG. 9 is a structural diagram of an example login device according to an example embodiment of the present disclosure.

### DETAILED DESCRIPTION

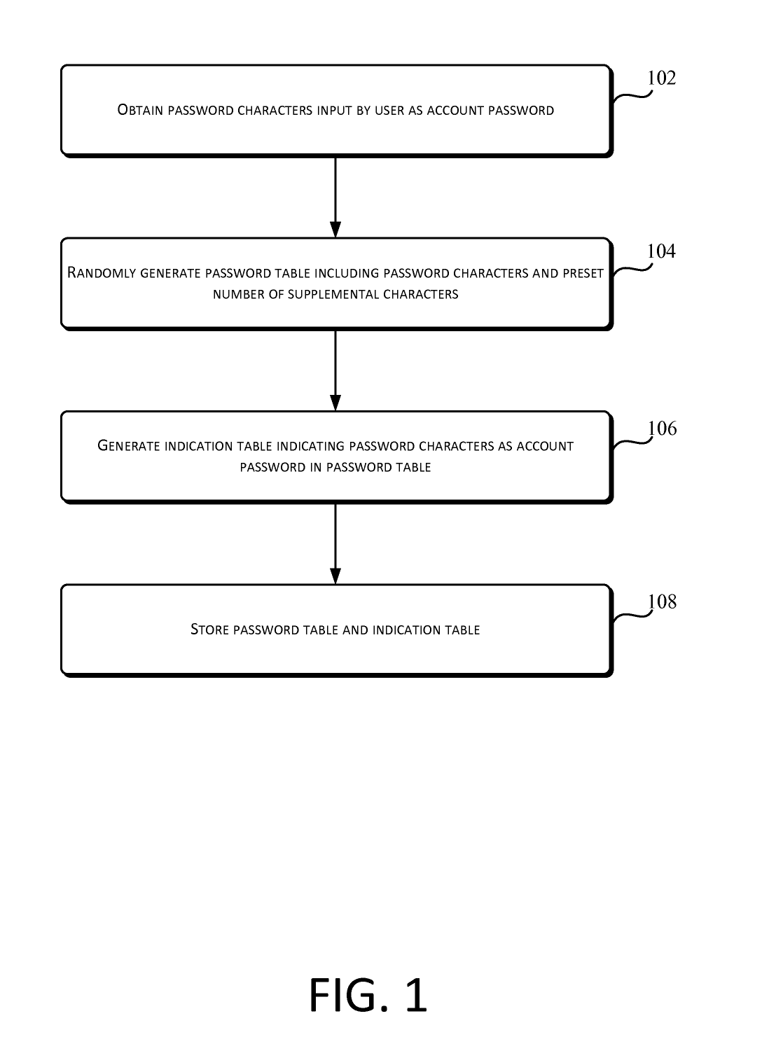

To illustrate the technical objectives, solutions, and advantages of the example embodiments of the present disclosure, the technical solutions of the present disclosure are described by reference to the FIG. 1t is apparent that the example embodiments are only part of, and not all of, of the embodiments of the present disclosure. All of the other embodiments obtained by one of ordinary skill in the art based on the example embodiments without using creative efforts fall under the protection of the present disclosure.

FIG. 1 is a flow chart of an example password configuration method according to an example embodiment of the present disclosure.

At 102, password characters input by a user as an account password are obtained. At 104, a password table including the password characters and a preset number of supplemental characters is randomly generated. At 106, an indication table indicating the password characters as the account password in the password table is generated. At 108, the password table and the indication table are stored.

An entity that implements the example embodiment may be a password configuration device. In actual implantation, the device may be any device including installed software on the memory of the device that requires password configuration, such as server, personal computer, cell phone, a web browser on a device.

When conducting password configuration, the password configuration device may display password prompt message and password input box to the user to prompt the user to configure password.

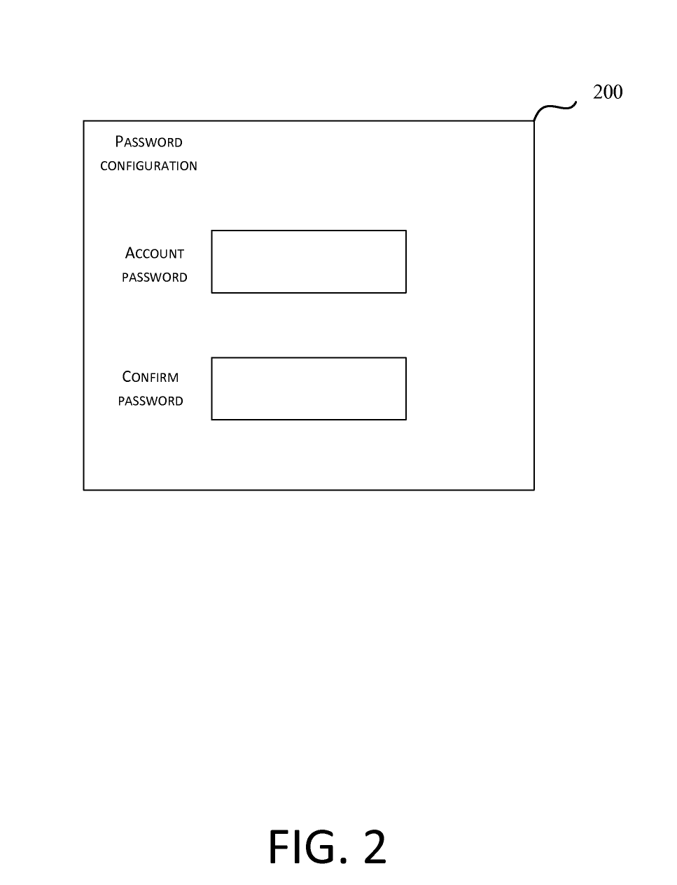

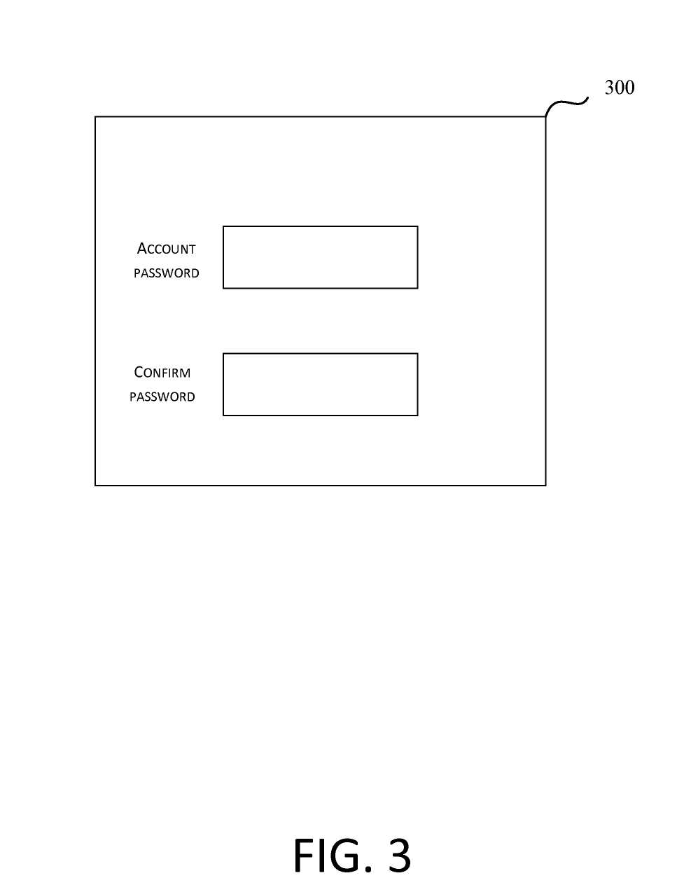

The password configuration device may display the password configuration prompt message to the user. As shown in FIG. 2, at the top left corner of a user interface 200, a phrase “password configuration” is directly displayed. Alternatively, the password configuration device may display the password prompt message to the user implicitly. As shown in FIG. 3, a user interface 300 in FIG. 3 does not directly present password configuration prompt message. The user only needs to confirm password during the process of password configuration. Thus, the phrase “confirm password” in FIG. 3 provides function of prompt of password configuration, which is equivalent to display password configuration prompt message to the user.

After the password configuration prompt message and the password input box are displayed, the user may input the password characters as the account password through the password input box. The password configuration device obtains the password characters input by the user through the password input box.

In the example embodiment, to overcome the low password security under conventional password configuration method, the password configuration device, after obtaining the password characters input by the user, does not directly store the password characters. Instead, the password configuration device randomly generates the password table. The password table includes the password characters as the account password and a preset number of supplemental characters. The supplemental characters are characters different from the password characters. The present disclosure does not impose restriction on the total number of characters included in the password table. Depending on the total number of characters include in the password table, the number of the supplemental characters may also be different. For example, the password table may include 64 characters. According to the number (or length) of the password characters, the number of the supplement characters is determined.

For example, as the password table is randomly generated, a position relationship between any of the password characters input by the user and any of the supplemental characters is also random.

In the example embodiment, the password configuration device randomly generates the password table, and mixes the password characters and the supplemental characters. Even if the password table is hacked, it is difficult for the hacker to determine the password characters used as the account password, thereby increasing password security.

In addition, when the user logs in, there is verification of the characters input by the user during login based on the configured password characters input by the user. Thus, the password characters in the password table need to be identified. The password configuration device generates the indication table, which indicates the password characters in the password table that are used as the account password, thereby solving password confirmation when the user logs in.

Although the password table and the indication table are used to determine the password characters as the account password in the example embodiment, a possibility that both of the two tables are hacked is low. Even if both of the two tables are hacked, it is difficult for the hacker to analyze a relationship between the two tables. Therefore, the password configuration method provided by the example embodiment still has great technical advantages in improving data security.

Optionally, the password table is unchangeable once it is generated. In other words, positions of the password characters in the password table are not changed. The password configuration device may generate the indication table as follows. Position information of the password characters in the password table is determined. Such position information is stored in the indication table. The position information indicates the password characters in the password table that are used as the account password. The techniques of this example embodiment are easy to be implemented.

Optionally, to further improve the security of the password characters, the positions of the password characters in the password table are periodically updated after the password table is generated. For example, an updating rule and an updating period may be preset. Based on the preset updating period, the updating rule is periodically applied to change the position of the password characters in the password table. Accordingly, the password configuration device may generate the indication table as follows. Initial position information of the password characters in the password table is determined. The initial position information, the updating period and the updating rule that updates the position of the password characters in the password table are stored in the indication table. When the password characters are retrieved, the initial position information, the updating period, and the updating rule are obtained from the indication table and the current positions of the password characters in the password table are calculated based on such three pieces of information. This implementation method may further improve password security.

Optionally, to further reduce the possibility that both of the two tables (i.e., the password table and the indication table) are hacked and to improve the password security, the password configuration device may store the password table at a local device and store the indication table at a remote device. That is, the password table and the indication table are separately stored. For example, the local device may be the password configuration device itself. The remote device may be a remoter server that communicates with the password configuration device but is separation from the password configuration device, such as a cloud server.

As the conventional password characters take the form of numbers, capitalized or non-capitalized letters, and some special symbols, there is a problem of difficult memorization and easily inputting wrong password. Optionally, to solve the problem of different memorization and easily inputting wrong password, the techniques of the present disclosure provides a new form of password that supports the user to use a word, phrase, term, or sentence in the natural language used by the user as the password characters of the password.

Such password characters comply with the language habit of the user, are easy for memorization and reduce the possibility of inputting wrong password, which is easy to be used by the user. In addition, the user may use his/her favorite word, phrase, term, or sentence as the password characters, which is easy for the user to memorize, reduces the possibility of inputting wrong password, and is easy for use. Considering that there is a large quantity of words, phrases, terms, or sentences in different languages, there is a wide selection rage for the user to select password characters so that the security that the user uses the words, phrases, terms, or sentences in the language as the password characters is ensured.

For example, the languages used by the user may be German or non-Western natural languages such s Chinese, Japanese, etc. The words, phrases, terms, or sentences refer to the words, phrases, terms, or sentences complying with corresponding language specifications.

For example, corresponding to the specific implementation of the password configuration device, the user may use a corresponding inputting device, such as using a mouse or an input pen to directly input the word, phrase, term, or sentence that the user intends to use as the account password in the password input box. Thus, the password configuration device obtains the word, phrase, term, or sentence that the user inputs into the password input box as the account password. For instance, the language used by the user is Chinese. The user may input a Chinese word “ [symbol] ” (horse in English), a Chinese term “ [symbol] ” (“hurry up” in English), a Chinese phrase “ [symbol] ” (“Meeting now I will run” in English), a Chinese sentence “ [symbol] ” (“Facing the ocean, feel warm spring and blossom flower” in English), etc. as the account password.

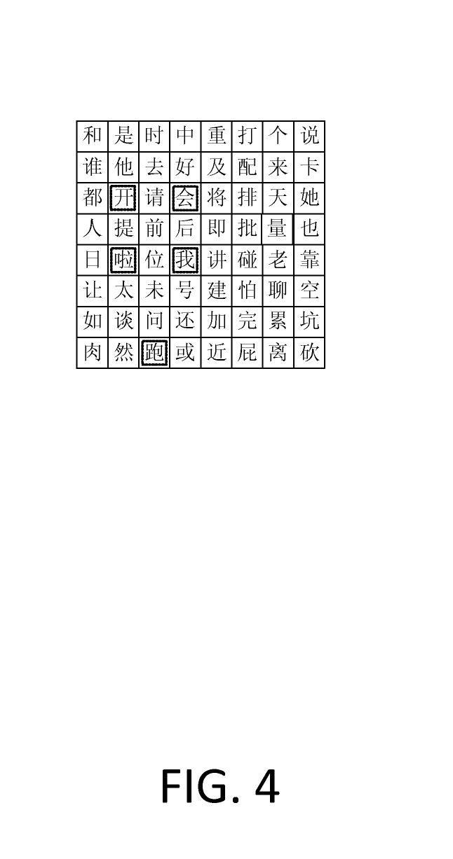

For the example of the password characters that use the word, phrase, term, or sentence in the language used by the user, FIG. 4 illustrates an example implementation of the password table. This password table includes 64 Chinese words. Among the 64 Chinese words, “ [symbol] ” “ [symbol] ” “ [symbol] ” “ [symbol] ” “ [symbol] ” are password characters that the user input as the account password. A number of the Chinese words in the password table is not limited to 64 and the included Chinese words in the password table is not limited to those as shown in FIG. 4. In other words, there are multiple implementations of the password table.

Optionally, to facilitate managing the account password, a length of the account password may be preset. That is, a number of the password characters that are used as the account password shall be within a designated range. For example, the length of the account password may be the number of the password characters. When the user sets the password characters, the user may input the password characters that meet the length requirement in the password input box. For instance, when the language used by the user is Chinese, if the preset length of the account password is between 4 and 7 Chinese words, the user may set 4 to 7 Chinese words as the password characters, or set a phrase or sentence including 4 to 7 Chinese words as the password characters.

Optionally, when the password characters input by the user through the password input box are obtained, the password configuration device may use preset hiding symbols to cover or represent the password characters input by the user and display the hiding symbols in the password input box to avoid password leakage from remote screenshot or peeking, thereby further improving the password security. For instance, the hiding symbol may be “*,” “#,” or any other character.

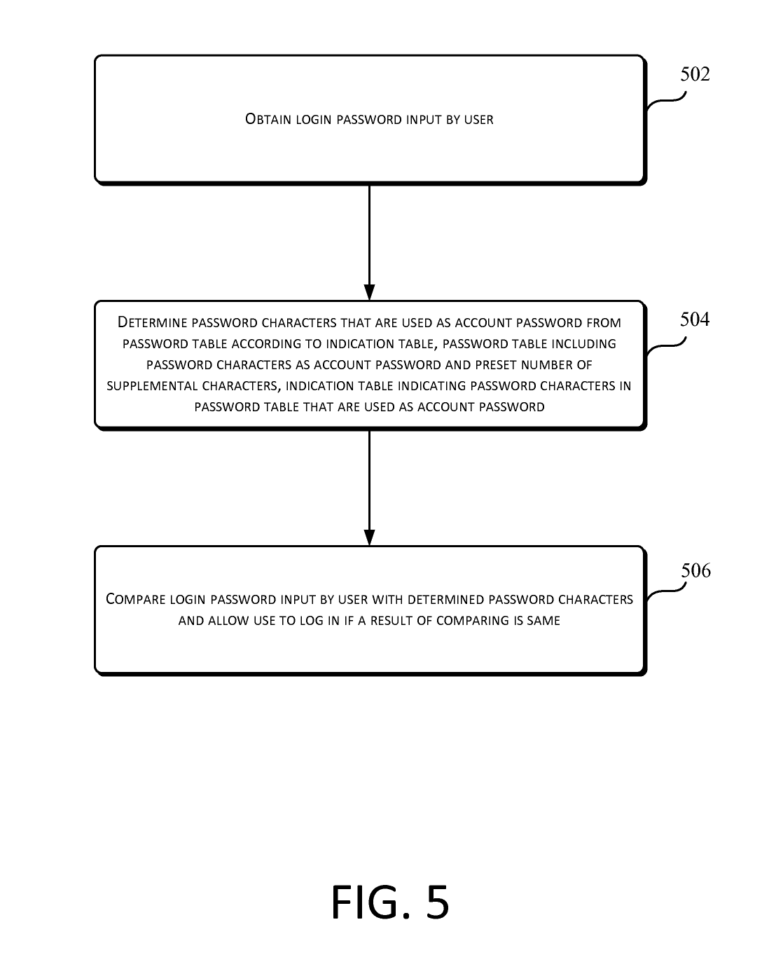

FIG. 5 illustrates a flowchart of an example login method according an example embodiment of the present disclosure.

At 502, a login password input by a user is obtained.

At 504, password characters that are used as an account password are determined from a password table according to an indication table. The password table includes the password characters as the account password and a preset number of supplemental characters. The indication table indicates the password characters in the password table that are used as the account password.

At 506, the login password input by the user is compared with the determined password characters. If a result of comparing is the same, the user is allowed to log in.

An entity implementing this example embodiment may be a login device. In actually implementation, the login device may be any device that requires log in or any device including installed software on the memory of the device that requires log in, such as server, personal computer, cell phone, a web browser on the device.

When the user needs to log in the through the password, the login device displays a user login prompt message and a password input box at a user interface to the user to prompt the user to log in.

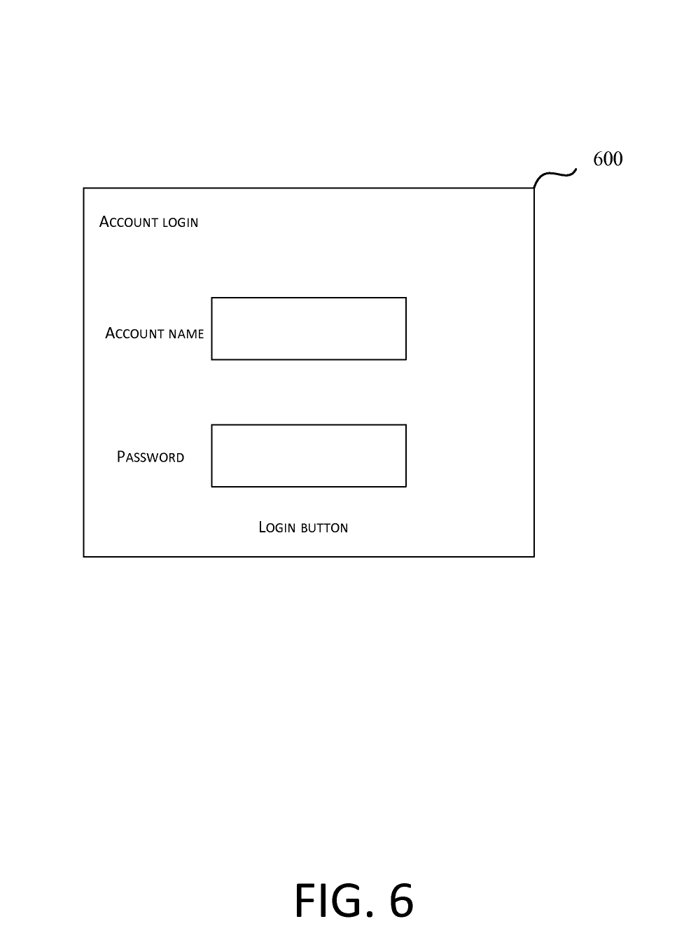

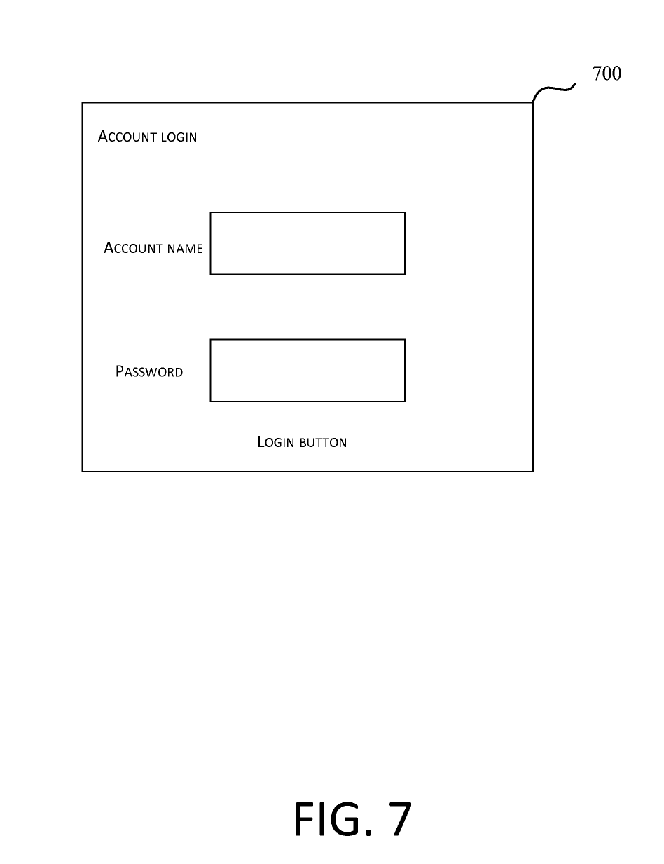

The login device may display the user login prompt message to the user. As shown in FIG. 6, the login device expressly displays the message “account login” at the top left corner of a user interface 600. Alternatively, the login device may implicitly display the login prompt message to the user. As shown in FIG. 7, a user interface 700 in FIG. 7 does not directly display the message “account login.” The login device displays an account name input box, a password input box, and a login button. Such message usually appears during the login process for the user, which is equivalent to display the login prompt message to the user.

After the login device displays the login prompt message and the password input box, the user inputs the login password through the password input box and the login device obtains the login password input by the user.

To resolve the problem of low password security under the conventional password configuration method, after obtaining the password characters input by the user, the password configuration device does not directly store the password characters and randomly generates the password table including the password characters and a designated number of supplemental characters. The supplemental characters are characters that are different from the password characters. In addition, considering that, when the user logs in, the characters input by the user for logging in are verified based on the password characters input by the user for password configuration, there is a need to identify the password characters in the password table. Thus, the password configuration device generates the indication table that indicates the password characters in the password table, thereby solving the problem of determining password when the user logs in.

Based on the above-described operations, after obtaining the login password input by the user, the login device obtains the indication table and the password table and determines the password characters as the account password from the password table according to the indication table. Then the login device compares the login password input by the user with the password characters determined from the password table. If a result of comparing is the same, the user is allowed to login and the user may be further reminded that the login is successful. If the result of comparing is different, the user is not allowed to log in.

For another example, the process that the login device determines the password characters as the account password from the password table according to the indication table may be as follows. The position information of the password characters in the password table is obtained from the indication table. The password characters are determined from the password table according to the position information.

For another example, the process that the login device determines the password characters as the account password from the password table according to the indication table may be as follows. The initial position information of the password characters in the password table, the updating period, and the updating rule that updates the positions of the password characters in the password table are obtained from the indication table. The password characters are determined from the password table according to the initial position information, the updating period, and the updating rule.

Further, considering that the password characters in the conventional techniques use numbers, capitalized or non-capitalized letters, or some special symbols, there is a problem of difficult memorization and inputting wrong password easily. In an example embodiment, to overcome the problem of difficult memorization and inputting wrong password easily, the techniques of the present disclosure provides a new form of password, i.e., by using the word, phrase, term, or sentence in the natural language used by the user as the password characters for the account password. Such password characters comply with the language habit of the user, are easy for memorization, and reduce the possibility of inputting the wrong password, which are convenient for the user.

The implementation of using the word, phrase, term, or sentence in the natural language used by the user as the password characters may refer to the above example embodiments, which are not detailed herein.

It is worth noting that, with respect to the above example method embodiments, for the purpose of the brevity, they are described as a series of operation combinations. One of ordinary in the art would appreciate that the present disclosure is not limited to a sequence of the described operations as, according to the techniques of the present disclosure, some operations may take another sequence or happen concurrently. Further, one of ordinary skill in the art would appreciate that the embodiments described in the present disclosure are example embodiments and some of the described operations and module may not be necessary for the techniques of the present disclosure.

Each of the above example embodiments has its emphasis. A portion that is not detailed in one example embodiment may refer to relevant portion in another example embodiment.

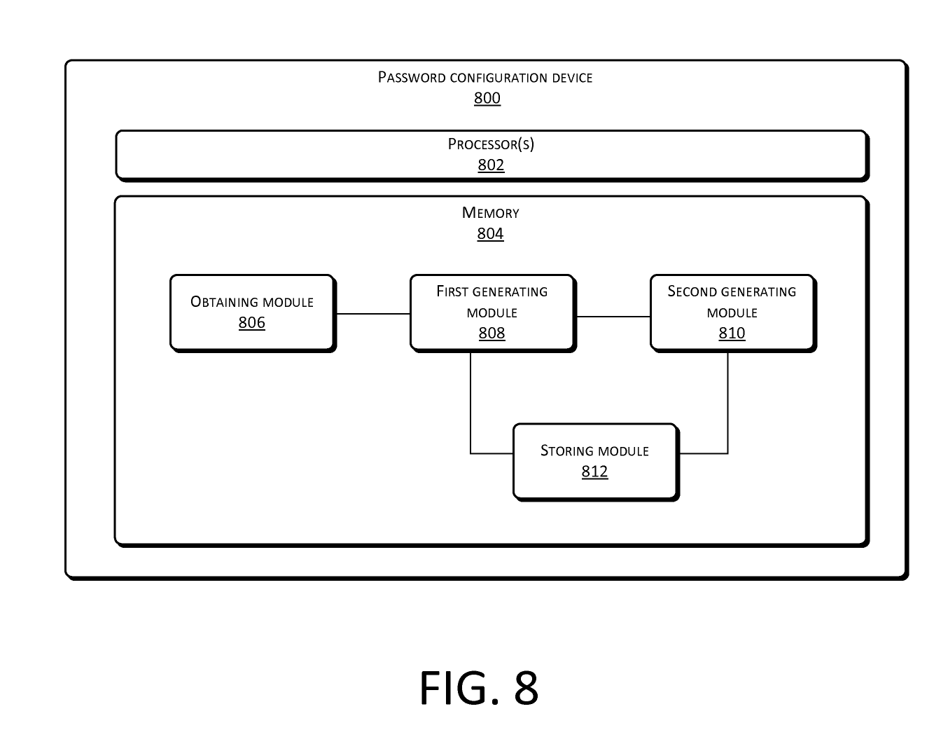

FIG. 8 illustrates a structural diagram of an example password configuration device 800 according to an example embodiment of the present disclosure. As shown in FIG. 8, the password configuration device 800 may include one or more processor(s) 802 or data processing and memory 804. The password configuration device 800 may further include one or more input/output apparatuses and network interfaces (not shown in FIG. 8). The memory 804 is an example of computer-readable media.

The computer-readable media includes permanent and non-permanent, movable and non-movable media that may use any methods or techniques to implement information storage. The information may be computer-readable instructions, data structure, software modules, or any data. The example of computer storage media may include, but is not limited to, phase-change memory (PCM), static random access memory (SRAM), dynamic random access memory (DRAM), other type RAM, ROM, electrically erasable programmable read only memory (EEPROM), flash memory, internal memory, CD-ROM, DVD, optical memory, magnetic tape, magnetic disk, any other magnetic storage device, or any other non-communication media that may store information accessible by the computing device. As defined herein, the computer-readable media does not include transitory media such as a modulated data signal and a carrier wave.

The memory 804 may store therein a plurality of modules or units including an obtaining module 806, a first generating module 808, a second generating module 810, and a storing module 812.

The obtaining module 806 obtains password characters input by a user as an account password. The first generating module 808 is connected with the obtaining module 806 and randomly generates a password table including the password characters and a preset number of supplemental characters. The second generating module 810 is connected with the first generating module 808 and generates an indication table indicating the password characters as the account password in the password table. The storing module 812 is connected with the first generating module 808 and the second generating module 810 and stores the password table generated by the first generating module 808 and the indication table generated by the second generating module 810.

Optionally, the second generating module 810 determines position information of the password characters in the password table generated by the first generating module 808, and stores the position information into the indication table.

Optionally, the first generating module 808 periodically updates the position of the password characters in the password table. The second generating module 810 determines initial position information of the password characters in the password table generated by the first generating module 806, and stores the initial position information and the updating period and the updating rule, used by the first generating module 808 in updating the position of the password characters in the password table, into the indication table.

Optionally, the storing module 812 stored the password table locally and the indicate table at a remote server.

Optionally, the obtaining module 806 obtains the password characters input by the user through the password input box as the account password. Further, when obtaining the password characters input by the user through the password input box as the account password, the obtaining module 806 uses preset hiding symbols to cover or replace the password characters input by the user, and displays the hiding symbols in the password input box.

Optionally, the password characters include word, phrase, term, or sentence in the natural language used by the user.

The password configuration device may be any device including installed software on the memory of the device that requires password configuration, such as server, personal computer, cell phone, a web browser on a device.

The password configuration device, after the user inputs the password characters used as the account password, randomly generates the password table including the password characters and supplemental characters and mixes the password characters and the supplemental characters. Even if the password table is hacked, it is difficult for the hacker to determine the password characters as the account password, which improves password security. In addition, the password configuration device uses the indication table to indicate the password characters as the account password in the password table, thereby solving the problem of determining password when the user logs in. Although the password configuration device uses two tables to determine the password characters as the account password, a possibility that both of the two tables are hacked is low. Even if both of the two tables are hacked, it is difficult for the hacker to analyze a relationship between the two tables. Therefore, the password configuration device of the present disclosure improves password security in setting password.

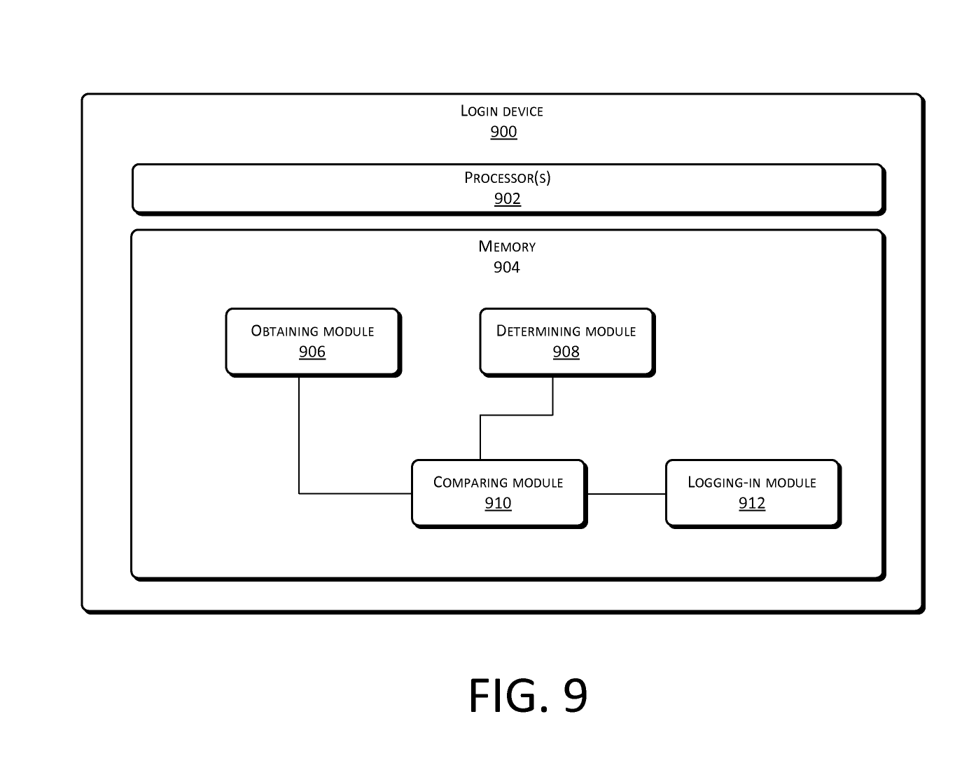

FIG. 9 illustrates a structural diagram of an example login device 900 according to an example embodiment of the present disclosure. As shown in FIG. 9, the login device 900 may include one or more processor(s) 902 or data processing and memory 904. The login device 900 may further include one or more input/output apparatuses and network interfaces (not shown in FIG. 9). The memory 904 is an example of computer-readable media.

The memory 904 may store therein a plurality of modules or units including an obtaining module 906, a determining module 908, a comparing module 910, and a logging-in module 912.

The obtaining module 906 obtains a login password input by a user. The determining module 908 determines password characters used as an account password from a password table according to an indication table. The password table includes the password characters as the account password and a preset number of supplemental characters. The indication table indicates the password characters as the account password in the password table. The comparing module 910 is connected with the obtaining module 906 and the determining module 908 and compares the login password with the account password. If a comparing result is that the login password is the same as the account password, the logging-in module 912, which is connected with the comparing module 910, allows the user to login.

Optionally, the determining module 908 obtains position information of the password characters in the password table from the indication table, and obtains the password characters from the password table according to the position information.

Optionally, the determining module 908 obtains the initial position information of the password characters in the password table, the updating period and the updating rule, which update the positions of the password characters in the password table, from the indication table, and determine the password characters from the password table according to the initial position information, the updating period, and the updating rule.

Optionally, the determining module 908, prior to determining the password characters used as the account password from the password table according to the indication table, obtains the password table from local storage or memory of the login device 900 and the indication table from a remote server.

Optionally, the login password or the password characters are word, phrase, term, or sentence in a natural language used by the user.

The login device may be any device including installed software on the memory of the device that requires the user to input password for login, such as server, personal computer, cell phone, a web browser on a device.

The login device of this example embodiment may cooperate with the password configuration device provided by the above example embodiment, which increases the password security.

One of ordinary skill in the art would understand that, for the purpose of brevity, the detailed operations of the above-described systems, devices, or modules may refer to the corresponding operations in the above example method embodiments, which are detailed herein.

In the example embodiments of the present disclosure, the describe systems, devices, and methods may be implemented by other forms. The above described example device embodiments are just illustrative. For example, a classification of the modules may be just a classification of logical functions. There may be other classifications in actual implementations. For example, multiple modules or units may be combined or integrated into one system. Alternatively, some features may be omitted or not implemented. In addition, the displayed or described connection, direct coupling, or communication connection may be conducted through indirect coupling or communication connection among the interfaces, devices, or units, which may be in the form of electric, mechanic, or any other form.

The modules that are described as separate components may be physically separate or may be not physically separate. The components, shown as the modules, may be physical components or may be not physical components. That is, the units may locate at one place or distribute across multiple network locations. Some or all of the units may be chosen to implement the techniques of the present disclosure according to actual needs.

In addition, the function units in the example embodiments of the present disclosure may be integrated into one processing unit. Alternatively, each unit is physically separate. Alternatively, two or more units are integrated into one unit. The units or integrated units may be in the form of hardware or a combination of hardware and software function units.

The integrated unit implemented by the function units may be stored at computer-readable media of a computing device. The software function units are stored in the computer-readable media and include one or more computer-readable instructions that cause the computing device (such as a personal computer, a server, or a network device) or a processor to perform operations described by the example embodiments of the present disclosure. The computer-readable media may include U disk, movable hard disk, Read-Only Memory, Random Access Memory, tape, disc, or any other form that stores the computer-readable instructions.

The above-described example embodiments are only used to illustrate the techniques of the present disclosure, and are not used to restrict the present disclosure. Although the example embodiment provide detail illustration of the present disclosure, one of ordinary skill in the art may modify the techniques in the example embodiments, or conduct equivalent replacement of some technical features of the techniques in the example embodiments. Such change or replacement do not cause the corresponding techniques beyond the spirit and scope of the techniques of the present disclosure, and shall still fall under the protection of the present disclosure.

What is claimed is:

1. A password configuration method comprising:
obtaining one or more password characters input by a user as an account password;
randomly generating a password table including the password characters and a preset number of supplemental characters; and
generating an indication table that indicates the password characters in the password table as the account password.

2. The method of claim 1, further comprising storing the password table and the indication table.

3. The method of claim 2, wherein the storing the password table and the indication table comprises:
storing the password table at a local device; and
storing the indication table at a remote device.

4. The method of claim 1, wherein the supplemental characters are one or more characters that are not password characters.

5. The method of claim 1, wherein the generating the indication table comprises:
determining position information of the password characters in the password table; and
storing the position information in the indication table.

6. The method of claim 1, further comprising periodically updating one or more positions of the password characters in the password table according to an updating period and an updating rule.

7. The method of claim 6, wherein the generating the indication table comprises:
determining initial position information of the password characters in the password table; and
storing the initial position information, the updating period, and the updating rule in the indication table.

8. The method of claim 1, wherein the password characters include a word, a phrase, a term, or a sentence in a natural language.

9. The method of claim 8, wherein the natural language is a non-Western language.

10. A login method comprising:
obtaining a login password input by a user;
determining one or more password characters from a password table according to an indication table, the password table including the password characters as an account password and a preset number of supplemental characters, the indication table indicating the password characters in the password table;
comparing the login password with the password characters; and
allowing the user to log in, in response to determining that a result of comparing is that the login password is same as the password characters.

11. The method of claim 10, wherein the determining the one or more password characters from the password table according to the indication table comprises obtaining position information of the password characters in the password table according to the indication table.

12. The method of claim 10, wherein the determining the one or more password characters from the password table according to the indication table comprises:
obtaining initial position information of the password characters in the password table, an updating period and an updating rule for updating position information of the password characters in the password table; and
determining the password characters from the password table according to the initial position information, the updating period, and the updating rule.

13. The method of claim 10, wherein the supplemental characters are one or more characters that are not password characters.

14. The method of claim 10, wherein the password characters include a word, a phrase, a term, or a sentence in a natural language.

15. The method of claim 14, wherein the natural language is a non-Western natural language including Chinese.

16. A password configuration device comprising:
an obtaining module that obtains one or more password characters input by a user as an account password;
a first generating module that randomly generates a password table including the password characters and a preset number of supplemental characters; and
a second generating module that generates an indication table that indicates the password characters in the password table as the account password.

17. The device of claim 16, further comprising a storing module that stores the password table and the indication table.

18. The device of claim 16, wherein the second generating module further:
determines position information of the password characters in the password table; and
stores the position information in the indication table.

19. The device of claim 16, wherein:
the first generating module further periodically updates one or more positions of the password characters in the password table according to an updating period and an updating rule; and
the second generating module further:
determines initial position information of the password characters in the password table; and
stores the initial position information, the updating period, and the updating rule in the indication table.

20. The device of claim 16, wherein the password characters include a word, a phrase, a term, or a sentence in a non-Western natural language.
